(19) United States
(12) Patent Application Publication
(10) Pub. No.: US 2025/0102003 A1
(43) Pub. Date: Mar. 27, 2025

(54) FASTENER

(71) Applicant: YKK CORPORATION, Tokyo (JP)

(72) Inventors: Jun SHITAKA, Kurobe-shi (JP); Minori HAYASHI, Kurobe-shi (JP); Tomokazu KUSAJIMA, Kurobe-shi (JP)

(21) Appl. No.: 18/892,185

(22) Filed: Sep. 20, 2024

(30) Foreign Application Priority Data
Sep. 27, 2023 (JP) 2023-166230

(51) Int. Cl. F16B 9/00

(52) U.S. Cl. CPC F16B 9/07

(57) ABSTRACT

A fastener includes a plug having a shape of a rotating body and a socket into which the plug is inserted in an axial direction. The socket includes a strap attachment portion to which a strap is to be attached and a socket body that forms a housing space in which the plug is disposed. The socket body includes a spring that includes a pair of ends arranged side by side in the axial direction and that faces, on one side in a thickness direction orthogonal to the axial direction, the housing space; a pair of supports that each support a corresponding one of the pair of ends of the spring; and a stop that faces, on the other side in the thickness direction, the housing space. The spring includes, between the pair of ends, a pressing portion that presses the plug disposed in the housing space against the stop.

### CROSS REFERENCE TO RELATED APPLICATIONS

The entire disclosure of Japanese Patent Application No. 2023-166230 filed Sep. 27, 2023, is expressly incorporated by reference herein.

### TECHNICAL FIELD

The present invention relates to a fastener configured to make a strap attachable to and detachable from an article.

### BACKGROUND ART

A strap that is attached to an article, such as a camera, to be used to dangle the article has been widely used. In the related art, there is a fastener configured to make a strap easily attachable to and detachable from an article. For example, the fastener disclosed in Literature 1 (Chinese Utility Model No. 218605357) includes a socket to which a strap is to be fastened and a plug that is insertable into and extractable from the socket, and a string body that is to be fastened to an article is fixed to the plug. A user can detach the strap from an article by extracting the plug from the socket.

When the fastener described above is used, there is a likelihood that the plug is inserted into the socket in a state in which a twist is generated between an article and a strap. In the fastener in Chinese Utility Model No. 218605357, the plug is configured to be rotatable with respect to the socket, thereby suppressing such a twist. In the fastener in Literature 1, a magnet is used for the socket to guide and hold the plug, and attachment and detachment are easy. However, the plug may come off accidentally when receiving an unintended external force that causes the plug to incline with respect to the strap and the like. It is thus difficult to ensure sufficient attachment strength in actual use.

### SUMMARY OF THE INVENTION

An object of the invention is to provide a fastener configured to ensure a sufficient attachment strength while suppressing a twist between an article and a strap.

[1] A fastener according to one aspect of the invention includes a plug that has a shape of a rotating body and a socket into which the plug is inserted in an axial direction, the socket including a strap attachment portion to which a strap is to be attached and a socket body that forms a housing space in which the plug is disposed, the socket body including a spring that includes a pair of ends arranged side by side in the axial direction and that faces, on one side in a thickness direction orthogonal to the axial direction, the housing space, a pair of supports that each support a corresponding one of the pair of ends of the spring, and a stop that faces, on another side in the thickness direction, the housing space, the spring including, between the pair of ends, a pressing portion that presses the plug disposed in the housing space against the stop.

[2] In the aforementioned fastener in [1], preferably, the spring and the pair of supports are integrally molded.

[3] In the aforementioned fastener in [1] or [2], preferably, the socket body further includes a pair of lateral walls that are disposed with the housing space interposed between the pair of lateral walls in a width direction orthogonal to each of the axial direction and the thickness direction, and the pair of lateral walls include respective lateral-wall ends that are curved inward in the width direction so as to form the stop.

[4] In the aforementioned fastener in [3], preferably, the socket body further includes a pair of projections that each project, on one side of the housing space in the axial direction, inward in the width direction from a corresponding one of the pair of lateral walls, and a rear end of the plug disposed in the housing space in an insertion direction of the plug is able to be in contact with the pair of projections in the axial direction.

[5] In the aforementioned fastener in [4], preferably, the pressing portion applies a pressing force to the rear end of the plug.

[6] In the aforementioned fastener in any one of [3] to [5], preferably an operation opening through which the plug is exposed on the one side in the thickness direction from the housing space is formed between the respective lateral-wall ends of the pair of lateral walls, and a dimension of the operation opening in the width direction in a first opening region in which a rear end of the plug in an insertion direction of the plug is exposed is larger than a dimension of the operation opening in the width direction in a second opening region in which a leading end of the plug in the insertion direction is exposed.

[7] In the aforementioned fastener in any one of [3] to [6], preferably, the plug includes a plug body that has a cylindrical shape, and a flange that projects radially outward from the plug body.

[8] In the aforementioned fastener in any one of [3] to [7], preferably, the socket further includes a cover that is attached to the socket body, and the cover includes a plate and a pair of plug supports that project toward the one side in the thickness direction from the plate so as to be each inserted into a gap that is formed between the spring and a corresponding one of the pair of lateral walls.

According to the invention, it is possible to provide a fastener that is capable of ensuring sufficient attachment strength while suppressing a twist between an article and a strap.

### BRIEF DESCRIPTION OF DRAWINGS

FIG. 1 is a perspective view of a fastener according to a first exemplary embodiment of the invention.

FIG. 2 is a front view of a socket in the first exemplary embodiment.

FIG. 3 is a sectional arrow view taken along the line III-III in FIG. 2.

FIG. 4 is a sectional arrow view taken along the line IV-IV in FIG. 2.

FIG. 5 is a side view of the socket in the first exemplary embodiment.

FIG. 6 is a rear view of the socket in the first exemplary embodiment.

FIG. 7 is a view for describing an operation of the fastener in the first exemplary embodiment.

FIG. 8 is another view for describing an operation of the fastener in the first exemplary embodiment.

FIG. 9 is a front view of the fastener in the first exemplary embodiment.

FIG. 10 is a sectional view of a socket of a fastener according to a second exemplary embodiment of the invention.

### DETAILED DESCRIPTION

### First Exemplary Embodiment

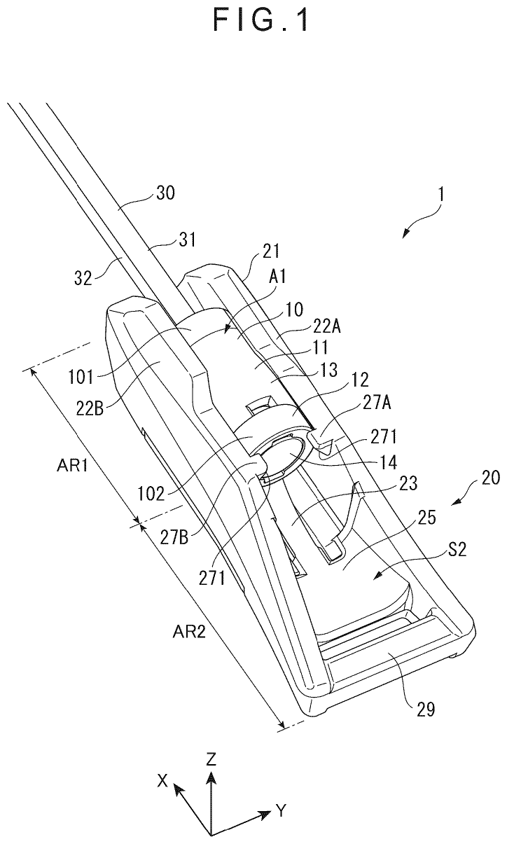

A first exemplary embodiment of the invention will be described on the basis of FIG. 1 to FIG. 8.

As illustrated in FIG. 1, a fastener 1 in the exemplary embodiment includes a plug 10 and a socket 20 into which the plug 10 is inserted. An article fastening portion (for example, a string body 30 in the exemplary embodiment) is attached to the plug 10. The string body 30 is attached to any article, such as a camera. A strap that is to be hung around a part (for example, the neck) of the body of a user is attached to the socket 20. A user can easily attach and detach the strap to and from the article by inserting or extracting the plug 10 into or from the socket 20.

Hereinafter, the width direction (left-right direction) of the fastener 1 is referred to as the Y-axis direction, the thickness direction (up-down direction) of the fastener 1 orthogonal to the Y-axis direction is referred to as the Z-axis direction, and a direction orthogonal to each of the Y-axis direction and the Z-axis direction is referred to as the X-axis direction (axial direction). In addition, one side and the other side in the X-axis direction are referred to as the +X side and the −X side, respectively, and one side and the other side in the Z-axis direction are referred to as the +Z side and the −Z side, respectively. In the following description, the XYZ directions are used on the basis that the plug 10 is in a state of having being inserted into the socket 20.

### Configuration of Plug 10

The plug 10 has any shape of a rotating body, and a direction along the center axis of the plug 10 corresponds to the X-axis direction (axial direction) in the exemplary embodiment. Specifically, as illustrated in FIG. 1, the plug 10 includes a cylindrical plug body 11 and an annular flange 12 that is provided at the plug body 11. Hereinafter, one end (a leading end in an insertion direction of the plug 10) of the plug 10 on the +X side is referred to as a plug leading end 101, and the other end (a rear end in the insertion direction of the plug 10) of the plug 10 on the −X side is referred to as a plug rear end 102.

The string body 30, which is an article attachment portion in the exemplary embodiment, is attached to the plug leading end 101. The string body 30 forms a loop (not illustrated), and both ends 31 and 32 of the string body 30 are connected to the plug leading end 101. The flange 12 protrudes radially outward at the plug rear end 102 from the plug body 11.

The specific configuration of the plug 10 and the method of connecting the string body 30 to the plug 10 are not particularly limited. For example, the plug 10 in the exemplary embodiment is constituted by combining a cylindrical member 13 that forms most part of the plug body 11 and the flange 12 with a cover member 14 that covers an opening of the cylindrical member 13. The both ends 31 and 32 of the string body 30 may be connected to the plug 10 by forming a knot in the internal space of the cylindrical member 13 while being inserted in a hole (not illustrated) in the bottom of the cylindrical member 13. Alternatively, the both ends 31 and 32 of the string body 30 may be connected to the plug 10 by insert-molding when the plug 10 is molded with a resin.

### Configuration of Socket 20

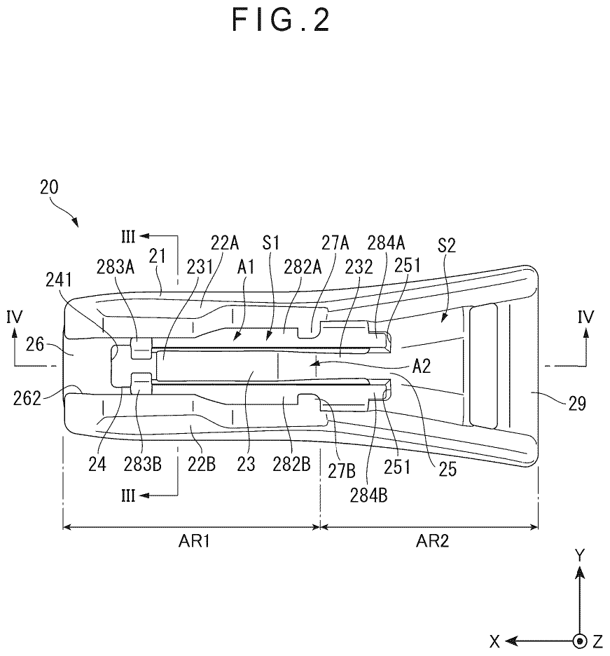

A configuration of the socket 20 will be described with reference to FIG. 2 to FIG. 6.

The socket 20 includes a socket body 21, a cover 28 that is attached to the socket body 21, and a strap attachment portion 29 that extends from the socket body 21. In the exemplary embodiment, the socket body 21 and the strap attachment portion 29 are integrally molded with a resin. The cover 28 is molded with a resin and is attached to the socket body 21.

As illustrated in FIG. 2, the socket body 21 forms a housing space S1 that houses the plug 10, and a guiding space S2 that guides the plug 10 to the housing space S1. Specifically, the socket body 21 includes a pair of lateral walls 22A and 22B that face each other in the Y-axis direction; a spring 23 that is disposed between the pair of lateral walls 22A and 22B and that extends in the X-axis direction; a pair of supports 24 and 25 that support the spring 23; a bottom wall 26 that couples +X side ends of the pair of lateral walls 22A and 22B to each other; and a pair of projections 27A and 27B that project inward in the Y-axis direction from the pair of lateral walls 22A and 22B, respectively.

The following description is based on that the socket body 21 has a first region AR1 in which the housing space S1 is formed and a second region AR2 in which the guiding space S2 is formed. The first region AR1 and the second region AR2 are arranged side by side in the X-axis direction.

The lateral walls 22A and 22B face each other in the Y-axis direction and each have a shape of a wall that extends over the first region AR1 and the second region AR2. The lateral walls 22A and 22B in the first region AR1 are disposed with the housing space S1 interposed therebetween, and the lateral walls 22A and 22B in the second region AR2 are disposed with the guiding space S2 interposed therebetween.

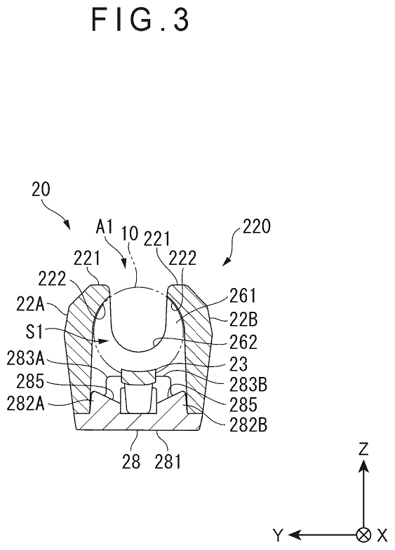

As illustrated in FIG. 3, the lateral walls 22A and 22B in the first region AR1 include respective lateral-wall ends 221, which are ends on the +Z side. The lateral-wall end 221 of each of the lateral walls 22A and 22B has a shape curved inward in the Y-axis direction and forms an abutment surface 222 that faces, on the −Z side, the housing space S1. The abutment surface 222 can be in contact, on the −Z side, with the plug 10 disposed in the housing space S1. The respective lateral-wall ends 221 of such lateral walls 22A and 22B constitute a stop 220 that faces the spring 23 with the housing space S1 interposed therebetween.

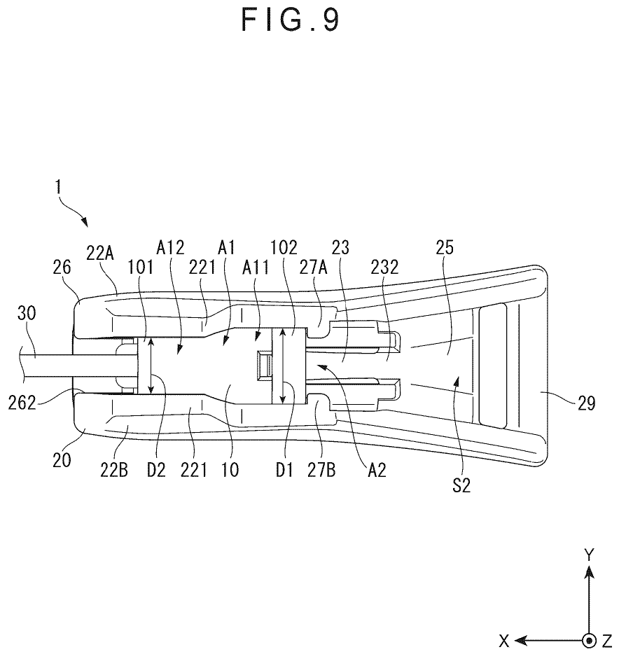

In the first region AR1, an operation opening A1 through which the plug 10 is exposed on the +Z side from the housing space S1 is formed between the respective lateral-wall ends 221 of the lateral walls 22A and 22B. Here, as illustrated in FIG. 1, a portion of each of the lateral walls 22A and 22B on the −X side in the first region AR1 has a notched shape that is notched toward the −Z side. Consequently, the operation opening A1 includes a plurality of opening regions that differ from each other in dimensions in the Y-axis direction. Specifically, as illustrated in FIG. 9, a dimension D1 of the operation opening A1 in the Y-axis direction in a first opening region A11, in which the plug rear end 102 is exposed, is larger than a dimension D2 of the operation opening A1 in the Y-axis direction in a second opening region A12, in which the plug leading end 101 is exposed.

As illustrated in FIG. 2, each of the lateral walls 22A and 22B in the second region AR2 has a shape that is curved outward in the Y-axis direction toward the −X side. In addition, as illustrated in FIG. 1, the lateral walls 22A and 22B in the second region AR2 become smaller in dimensions in the Z-axis direction toward the −X side.

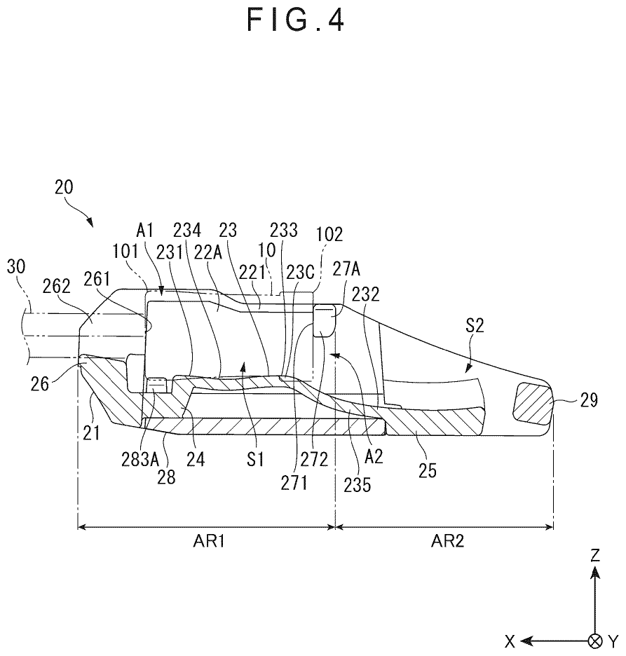

As illustrated in FIG. 3, the spring 23 is disposed between the pair of lateral walls 22A and 22B so as to face, on the +Z side, the housing space S1. As illustrated in FIG. 4, the spring 23 has a shape of a plate spring extending in the X-axis direction and includes a pair of ends 231 and 232 that are arranged side by side in the X-axis direction. Hereinafter, in the pair of ends 231 and 232, the end 231 that is disposed on the +X side is referred to as the spring leading end 231, and the end 232 that is disposed on the −X side is referred to as the spring rear end 232.

In the exemplary embodiment, the spring 23 extends over the first region AR1 and the second region AR2 of the socket 20 with the spring leading end 231 disposed in the first region AR1 and the spring rear end 232 disposed in the second region AR2.

The spring 23 includes, between the spring leading end 231 and the spring rear end 232, a bent portion 23C that is bent in the Z-axis direction. A portion (hereinafter referred to as a first extension 234) of the spring 23 from the spring leading end 231 to the bent portion 23C is disposed to extend in the X-axis direction. In addition, a portion (hereinafter referred to as a second extension 235) of the spring 23 from the bent portion 23C to the spring rear end 232 is disposed to incline with respect to the X-axis direction such that the further the portion extends toward the −X side, the further the portion inclines toward the −Z side. The spring rear end 232 is thus disposed on the −Z side from the spring leading end 231.

The spring 23 is elastically deformable toward the −Z side with the above-described bent portion 23C as the center of the deformation. When the plug 10 is disposed in the housing space S1, the spring 23 is elastically deformed toward the −Z side by being pressed by the plug 10. Such an elastic deformation will be specifically described later. The spring 23 thus includes a pressing portion 233 that applies, by using the elastic force thereof, a pressing force toward the +Z side with respect to the plug 10 disposed in the housing space S1. The pressing portion 233 is a portion on the +X side of the bent portion 23C and presses, in particular, the plug rear end 102 of the plug 10 disposed in the housing space S1 against the stop 220.

As illustrated in FIG. 2, the supports 24 and 25 are disposed at positions away from each other in the X-axis direction and each have a plate shape extending in the X-axis direction and in the Y-axis direction. In addition, the supports 24 and 25 couple the pair of lateral walls 22A and 22B to each other. Specifically, the support 24 couples the pair of lateral walls 22A and 22B to each other in the first region AR1 and faces, on the +Z side, the housing space S1. Meanwhile, the support 25 couples the pair of lateral walls 22A and 22B to each other in the second region AR2 and faces, on the +Z side, the guiding space S2.

The spring 23 described above is disposed in a gap between the supports 24 and 25 in the X-axis direction. The support 24 supports the spring leading end 231 while the support 25 supports the spring rear end 232. In other words, the supports 24 and 25 both support the spring 23.

In addition, the supports 24 and 25 each have a configuration for attaching the cover 28, which is described later, to the socket body 21. Specifically, as illustrated in FIG. 2, the support 24 has a recess 241 that opens on the +Z side, and first engagement portions 283A and 283B of the cover 28 are disposed in the recess 241. The support 25 has a pair of recesses 251 that are open on the +Z side, and second engagement portions 284A and 284B of the cover 28 are each disposed in a corresponding one of the recesses 251.

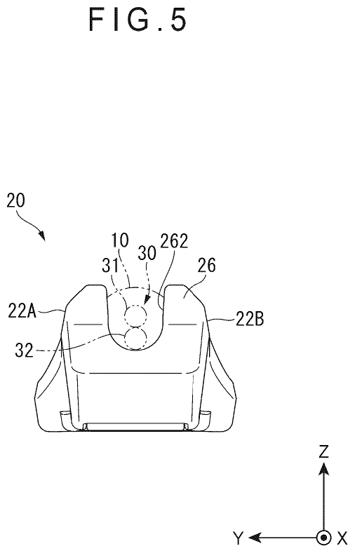

The bottom wall 26 is disposed on the +X side with respect to the housing space S1 and couples the +X side ends of the pair of lateral walls 22A and 22B to each other. As illustrated in FIG. 4, the bottom wall 26 has an abutment surface 261 that faces, on the −X side, the housing space S1. In addition, as illustrated in FIG. 5, the bottom wall 26 has a notch 262 into which the string body 30 is to be inserted in the X-axis direction, the notch 262 having a shape obtained by notching the bottom wall 26 toward the −Z side.

As illustrated in FIG. 2, the projections 27A and 27B are disposed at a −X side end of the housing space S1 and each have a shape that projects inward in the Y-axis direction from the lateral walls 22A or 22B corresponding thereto. Specifically, the projection 27A projects inward in the Y-axis direction from the lateral-wall end 221 of the lateral wall 22A, and the projection 27B projects inward in the Y-axis direction from the lateral-wall end 221 of the lateral wall 22B. As illustrated in FIG. 4, the projection 27A has an abutment surface 271 facing, on the +X side, the housing space S1 and an inclined surface 272 facing, on the −Z side, the housing space S1. The inclined surface 272 inclines with respect to the Y-axis direction and the Z-axis direction such that the further the inclined surface 272 extends inward in the Y-axis direction, the further the inclined surface 272 is positioned in the +Z direction. Although no illustration is provided, the projection 27B also has the abutment surface 271 and the inclined surface 272, similarly to the projection 27A.

The projections 27A and 27B form an insertion opening A2 of the housing space S1. The insertion opening A2 serves as an opening that makes the housing space S1 open in the −X direction. The plug 10 is housed in the housing space S1 through the insertion opening A2 from the guiding space S2.

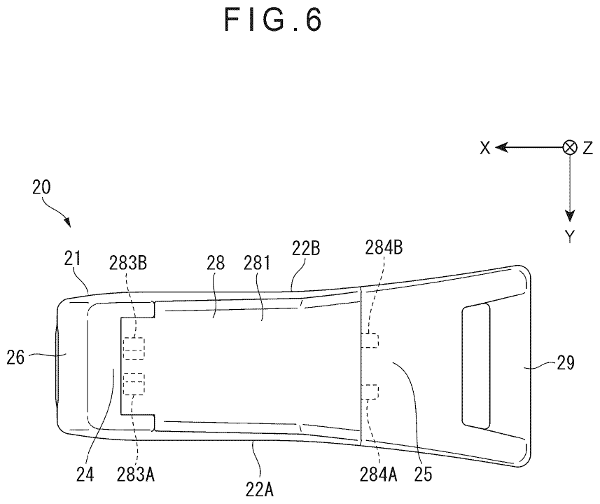

The cover 28 is disposed on the −Z side of the spring 23 and is attached to the socket body 21. Specifically, the cover 28 includes a plate 281 (refer to FIG. 6) that covers the −Z side of the spring 23; a pair of plug supports 282A and 282B (refer to FIG. 3) that project from the plate 281; a pair of the first engagement portions 283A and 283B (refer to FIG. 2) that project from +X side ends of the pair of plug supports 282A and 282B, respectively; and a pair of the second engagement portions 284A and 284B (refer to FIG. 2) that project from −X side ends of the pair of plug supports 282A and 282B, respectively.

As illustrated in FIG. 3, the plug support 282A is inserted toward the +Z side into a space between the lateral wall 22A and the spring 23, and the plug support 282B is inserted toward the +Z side into a space between the lateral wall 22B and the spring 23. These plug supports 282A and 282B each have a concave arc surface 285 that faces the +Z side. The arc surface 285 can be in contact with the plug 10 in the Z-axis direction to avoid an excessive elastic deformation of the spring 23.

As illustrated in FIG. 2, the first engagement portions 283A and 283B each have a claw shape that is fitted into the recess 241 of the support 24 while projecting toward the +Z side from the plug supports 282A or 282B corresponding thereto. The second engagement portions 284A and 284B project toward the −X side from the plug supports 282A and 282B, respectively, and are fitted into the recesses 251 of the support 25 corresponding thereto. With the first engagement portions 283A and 283B engaging with the support 24 while the second engagement portions 284A and 284B engaging with the support 25, the cover 28 is thereby attached to the socket body 21.

As illustrated in FIG. 1, the strap attachment portion 29 is shaped in a bar so as to be disposed to extend in the Y-axis direction and to couple −X side ends of the lateral walls 22A and 22B to each other. A gap is present between the strap attachment portion 29 and the support 25 in the X-axis direction, and a strap is to be hung around the strap attachment portion 29.

In the socket 20 in the exemplary embodiment described above, the plug 10 can be held among the abutment surfaces 271 of the pair of projections 27A and 27B and the abutment surface 261 of the bottom wall 26 in the X-axis direction. In addition, the plug 10 can be held between the pair of lateral walls 22A and 22B in the Y-axis direction. The plug 10 also can be held among the respective lateral-wall ends 221 (that is, the stop 220) of the pair of lateral walls 22A and 22B and the spring 23 in the Z-axis direction.

### Operation of Fastener 1

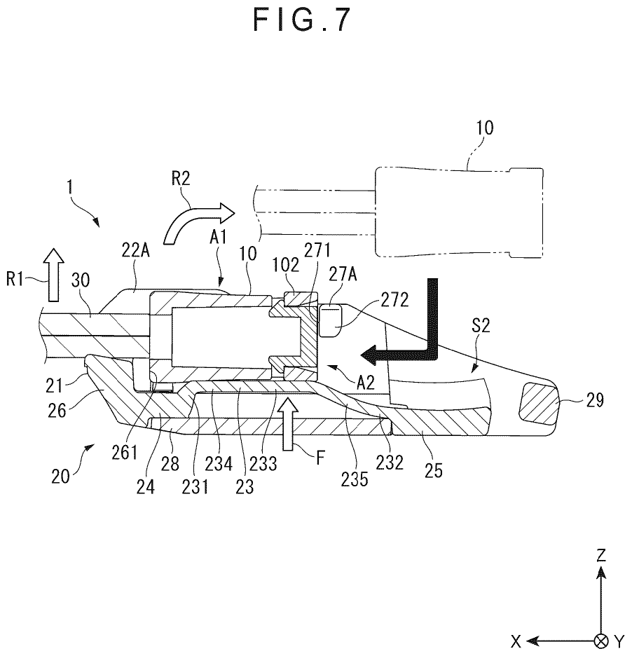

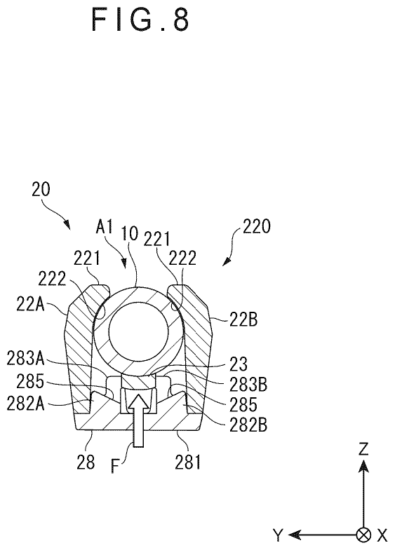

Operations of the plug 10 and the socket 20 during usage of the fastener 1 will be described with further reference to FIG. 7 and FIG. 8.

For example, to attach a strap to an article, a user disposes the plug 10 in the guiding space S2 of the socket 20 and applies a pressing force that includes a component toward the +X side and a component toward the −Z side with respect to the plug 10. Consequently, the plug 10 slides from the guiding space S2 of the socket 20 toward the housing space S1 (refer to FIG. 7). At this time, the plug 10 comes into contact with the second extension 235 of the spring 23, and the spring 23 receives a pressing force from the plug 10 and deforms toward the −Z side. Further, the plug 10 is guided by the inclined surfaces 272 of the projections 27A and 27B and is inserted into the housing space S1 through the insertion opening A2.

Next, the user releases the pressing force that has been applied to the plug 10. Then, the spring 23 attempts to return to an original shape thereof, and the pressing portion 233 of the spring 23 applies a pressing force F toward the +Z side with respect to the plug rear end 102. Consequently, as illustrated in FIG. 8, the plug 10 is held among the pressing portion 233 of the spring 23 and the respective lateral-wall ends 221 (that is, the stop 220) of the pair of lateral walls 22A and 22B in the Z-axis direction. Consequently, as illustrated in FIG. 9, insertion of the plug 10 into the socket 20 is completed, and a strap is thereby attached to an article.

When a twisting force that generates a twist is applied to the strap or the string body 30 while a user carries the article, the plug 10 rotates about the center axis extending in the X-axis direction with respect to the socket 20 while sliding with respect to the spring 23 and the stop 220. Consequently, generation of the aforementioned twist is suppressed.

To detach a strap from an article, the user applies a pressing force that includes a component toward the −X side and a component toward the −Z side with respect to the plug 10 through the operation opening A1 of the socket 20. At this time, the spring 23 receives a pressing force from the plug 10 and deforms toward the −Z side. The plug 10 thus moves toward the −X side while slightly moving toward the −Z side. Consequently, the plug 10 is inserted into the insertion opening A2 by being guided by the inclined surfaces 272 of the projections 27A and 27B and moves from the housing space S1 to the guiding space S2. Thereafter, the user takes out the plug 10, which has moved to the guiding space S2, from the socket 20.

Consequently, extraction of the plug 10 from the socket 20 is completed, and the strap is thus detached from the article.

### Effects of Exemplary Embodiment

As described above, the fastener 1 in the exemplary embodiment includes the plug 10 that has a shape of a rotating body and the socket 20 into which the plug 10 is inserted in the axial direction. The socket 20 includes the strap attachment portion 29 to which a strap is to be attached and the socket body 21 that forms the housing space S1 in which the plug 10 is disposed. The socket body 21 includes the spring 23 that includes the pair of ends 231 and 232 arranged side by side in the X-axis direction and that faces, on the +Z side, the housing space S1; the pair of supports 24 and 25 that support the pair of ends 231 and 232 of the spring 23, respectively; and the stop 220 that faces, on the −Z side, the housing space S1. The spring 23 includes, between the pair of ends 231 and 232, the pressing portion 233 that presses the plug 10 disposed in the housing space S1 against the stop 220.

With such a configuration, the plug 10 is held between the pressing portion 233 of the spring 23 and the stop 220 while being rotatable with respect to the socket 20. In addition, since the pressing portion 233 of the spring 23 is positioned between the pair of ends 231 and 232 that are supported by the supports 24 and 25, the strength of the spring 23 for pressing the plug 10 is easily ensured.

Meanwhile, in some cases, the string body 30 is moved as indicated by the arrow R1 in FIG. 7 by receiving a force from a strap or the like and a force is thereby applied to the plug 10 from the string body 30 as indicated by the arrow R2. In such cases, a force that detaches the plug 10 from the socket 20 while inclining the plug 10 acts on the plug 10. However, it is possible to suppress coming-off of the plug 10 by the pressing portion 233 of the spring 23 pressing the plug 10 against the stop 220.

Therefore, according to the fastener 1 in the exemplary embodiment, it is possible to ensure sufficient attachment strength while suppressing a twist between an article and a strap.

Further, when a magnet or a metallic spring is used as in the related art, environmental consideration, such as that separation for disposal is required, and costs are concerned. In contrast, since the fastener 1 in the exemplary embodiment can be molded with a resin, concern about environmental consideration, costs, and the like can be solved.

In the exemplary embodiment, the spring 23 and the pair of supports 24 and 25 are integrally molded.

With such a configuration, the strength of the spring 23 for pressing the plug 10 is more easily ensured. In addition, since a step of post-attachment of the spring 23 is unnecessary in manufacture of the fastener 1, manufacturing costs of the fastener 1 can be reduced.

In the exemplary embodiment, the socket 20 further includes the pair of lateral walls 22A and 22B that are disposed with the housing space S1 interposed therebetween in the Y-axis direction, and the pair of lateral walls 22A and 22B include the respective lateral-wall ends 221 that are curved inward in the Y-axis direction to form the stop 220.

With such a configuration, the stop 220 can be in contact with the plug 10 suitably.

In the exemplary embodiment, the socket body 21 further includes the pair of projections 27A and 27B that project, on the −X side of the housing space S1, inward in the Y-axis direction from the pair of lateral walls 22A and 22B, respectively, and the plug rear end 102 can be in contact with the pair of projections 27A and 27B in the X-axis direction.

With such a configuration, coming-off of the plug 10 in the −X-axis direction from the housing space S1 of the socket 20 can be suitably suppressed.

In the exemplary embodiment, the pressing portion 233 of the spring 23 applies a pressing force to the plug rear end 102.

For example, as described above, as a result of the string body 30 moving as indicated by the arrow R1 in FIG. 7, a force may be applied to the plug 10 as indicated by the arrow R2. In such a case, a force that lowers the plug rear end 102 in the −Z-axis direction acts on the plug 10. However, an inclination of the plug 10 can be suppressed since the pressing portion 233 of the spring 23 supports the plug rear end 102. As a result, a state in which the plug 10 can be in contact with the projections 27A and 27B is maintained, and coming-off of the plug 10 in the −X-axis direction can be more suitably suppressed.

In the exemplary embodiment, the operation opening A1 through which the plug 10 is exposed in the +Z-axis direction from the housing space S1 is formed between the respective lateral-wall ends 221 of the pair of lateral walls 22A and 22B. The dimension D1 of the operation opening A1 in the Y-axis direction in the first opening region A11, in which the plug rear end 102 is exposed, is larger than the dimension D2 of the operation opening A1 in the Y-axis direction in the second opening region A12, in which the plug leading end 101 is exposed.

In such a configuration, it is easy for a user to operate the plug 10 through the operation opening A1 to extract the plug 10 from the socket 20.

In the exemplary embodiment, the plug 10 includes the cylindrical plug body 11 and the flange 12 that projects from the plug body 11.

In such a configuration, when a user operates the plug 10 in the housing space S1, the flange 12 functions as a slip stopper for the fingers and the like of the user. Consequently, operability of the plug 10 can be improved.

In the exemplary embodiment, the socket 20 further includes the cover 28 that is attached to the socket body 21, and the cover 28 further includes the plate 281 and the pair of plug supports 282A and 282B that project in the +Z-axis direction from the plate 281 so as to be each inserted into a gap that is formed between the spring 23 and a corresponding one of the pair of lateral walls 22A and 22B.

In such a configuration, when a pressing force in the −Z-axis direction is applied to the plug 10, the plug supports 282A and 282B can be in contact with the plug 10 in the Z-axis direction. It is thus possible to avoid an excessive elastic deformation of the spring 23.

### Second Exemplary Embodiment

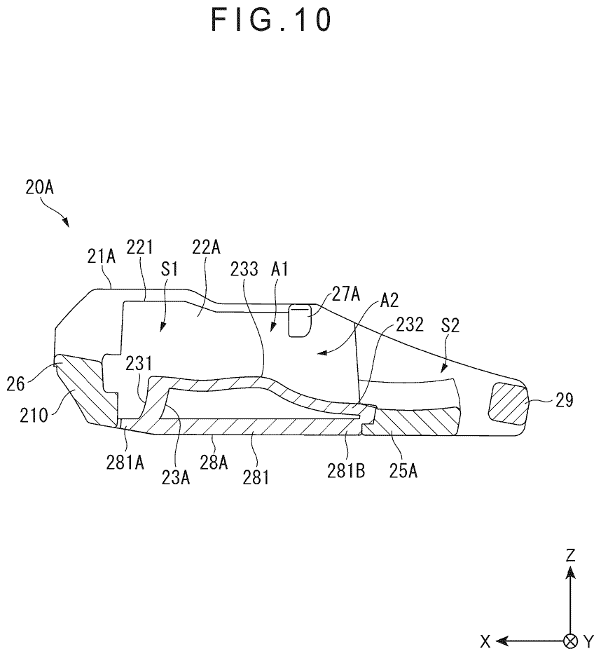

The fastener 1 in a second exemplary embodiment includes the same plug 10 as that in the first exemplary embodiment and a socket 20A having a configuration that differs from the configuration in the first exemplary embodiment. The socket 20A in the second exemplary embodiment will be described below with reference to FIG. 10. Note that the same components as those in the first exemplary embodiment are given the same signs as those in the first exemplary embodiment, and description thereof is omitted or simplified.

The socket 20A in the second exemplary embodiment includes a socket body 21A that forms the housing space S1 and the like, and the strap attachment portion 29 that extends from the socket body 21A. The socket body 21A includes a body base 210 and a cover 28A that is attached to the body base 210.

The body base 210 includes the socket body 21, except for the spring 23, described in the first exemplary embodiment. Specifically, the body base 210 includes the pair of lateral walls 22A and 22B that face each other in the Y-axis direction; the bottom wall 26 that couples the +X side ends of the pair of lateral walls 22A and 22B to each other; and the pair of projections 27A and 27B that project inward in the Y-axis direction from the pair of lateral walls 22A and 22B, respectively. The body base 210 also includes a wall 25A that couples the pair of lateral walls 22A and 22B to each other in the second region AR2 and that faces, on the +Z side, the guiding space S2.

The cover 28A includes the plate 281, a spring 23A that is provided at the plate 281, and an engagement portion, which is not illustrated. The cover 28A is integrally molded with a resin.

Similarly to the spring 23 in the first exemplary embodiment, the spring 23A includes the pair of ends 231 and 232 and faces, on the +Z side, the housing space S1. The both ends 231 and 232 of the spring 23A are supported by the plate 281. That is, both ends 281A and 281B of the plate 281 in the X-axis direction function as a pair of supports in the invention. The spring 23A also includes the pressing portion 233 that presses the plug 10 housed in the socket 20A.

Such a fastener in the second exemplary embodiment can exert the same effects as those in the first exemplary embodiment.

### Modification

The specific configuration of the fastener 1 in each of the aforementioned exemplary embodiments is not limited by the above description. Modifications of the first exemplary embodiment will be described below while the second exemplary embodiment may be also modified similarly.

In the first exemplary embodiment, the plug 10 is not limited to have a cylindrical shape and may have any shape of a rotating body so as to be rotatable with respect to the socket 20.

In the first exemplary embodiment, the socket 20 is not limited to include the cover 28. The cover 28 may be omitted. The pair of plug supports 282A and 282B of the cover 28 also may be omitted.

The operation opening A1 of the socket 20 in the first exemplary embodiment has the dimension D1 and the dimension D2 in the Y-axis direction that differ from each other. The invention is, however, not limited thereto. For example, the dimension of the operation opening A1 in the Y-axis direction may be constant in the X-axis direction. Further, in each of the aforementioned exemplary embodiments, the operation opening A1 of the socket 20 may be omitted with the socket 20 having a substantially cylindrical shape.

The pressing portion 233 of the spring 23 in the first exemplary embodiment applies a pressing force to the plug rear end 102. The invention is, however, not limited thereto. That is, the pressing portion 233 of the spring 23 may apply a pressing force to any portion (for example, a portion of the plug 10 on the −X side of a central portion of the plug 10 in the X-axis direction) of the plug 10.

In the first exemplary embodiment, the socket 20 is not limited to include the pair of projections 27A and 27B that form the insertion opening A2. The pair of projections 27A and 27B may be omitted. For example, since the −X side of an article, while the article is dangled on a strap, is assumed to correspond to the upper side in the vertical direction, the plug 10 is held by the socket 20 without a problem even when the movement of the plug 10 in the −X-axis direction from the housing space S1 is not restricted.

In the first exemplary embodiment, the lateral-wall ends 221 of the pair of lateral walls 22A and 22B may each have another shape as long as the lateral-wall ends 221 configure the stop 220. Further, in each of the aforementioned exemplary embodiments, the stop 220 may be not a part of the pair of lateral walls 22A and 22B and may be a portion of the cylindrical socket 20 that forms the housing space S1.

The socket body 21 in the first exemplary embodiment is integrally molded. The invention is, however, not limited thereto. For example, the spring 23 may be formed as a member that is separate from the socket body 21 and may be attached to the pair of supports 24 and 25.

The article fastening portion is the string body 30 in the first exemplary embodiment. The invention is, however, not limited thereto, and an article fastening portion having any configuration may be attached to the plug 10.

What is claimed is:

1. A fastener comprising:
a plug that has a shape of a rotating body; and
a socket into which the plug is inserted in an axial direction,
wherein the socket comprises:
a strap attachment portion to which a strap is to be attached; and
a socket body that forms a housing space in which the plug is disposed,
wherein the socket body comprises:
a spring that comprises a pair of ends arranged side by side in the axial direction and that faces, on a first side in a thickness direction orthogonal to the axial direction, the housing space;
a pair of supports that each support a corresponding one of the pair of ends of the spring; and
a stop that faces, on a second side in the thickness direction, the housing space, and
wherein the spring comprises, between the pair of ends, a pressing portion that presses the plug disposed in the housing space against the stop.

2. The fastener according to claim 1, wherein the spring and the pair of supports are integrally molded.

3. The fastener according to claim 1,
wherein the socket body further comprises a pair of lateral walls that are disposed with the housing space interposed between the pair of lateral walls in a width direction orthogonal to each of the axial direction and the thickness direction, and
wherein the pair of lateral walls comprise respective lateral-wall ends that are curved inward in the width direction so as to form the stop.

4. The fastener according to claim 3,
wherein the socket body further comprises a pair of projections that each project, on a first side of the housing space in the axial direction, inward in the width direction from a corresponding one of the pair of lateral walls, and
wherein a rear end of the plug disposed in the housing space in an insertion direction of the plug is configured to be in contact with the pair of projections in the axial direction.

5. The fastener according to claim 4, wherein the pressing portion applies a pressing force to the rear end of the plug.

6. The fastener according to claim 3,
wherein an operation opening through which the plug is exposed on the first side in the thickness direction from the housing space is formed between the respective lateral-wall ends of the pair of lateral walls, and
wherein a dimension of the operation opening in the width direction in a first opening region in which a rear end of the plug in an insertion direction of the plug is exposed is larger than a dimension of the operation opening in the width direction in a second opening region in which a leading end of the plug in the insertion direction is exposed.

7. The fastener according to claim 3, wherein the plug comprises: a plug body that has a cylindrical shape; and a flange that projects radially outward from the plug body.

8. The fastener according to claim 3,
wherein the socket further comprises a cover that is attached to the socket body, and
wherein the cover comprises:
a plate; and
a pair of plug supports that project toward the first side in the thickness direction from the plate so as to be each inserted into a gap that is formed between the spring and a corresponding one of the pair of lateral walls.
